(19) United States
(12) Patent Application Publication
(10) Pub. No.: US 2019/0126402 A1
(43) Pub. Date: May 2, 2019

(54) JOINING OF DISSIMILAR METALS

(71) Applicant: GM GLOBAL TECHNOLOGY OPERATIONS LLC, DETROIT, MI (US)

(72) Inventors: David Yang, Shanghai (CN); Wu Tao, Shanghai (CN)

(21) Appl. No.: 15/800,481

(22) Filed: Nov. 1, 2017

(51) Int. Cl. B23K 26/323; B23K 26/00; B23K 26/044

(52) U.S. Cl. CPC B23K 26/323; B23K 2203/04; B23K 26/044; B23K 26/0006

(57) ABSTRACT

A method of welding a workpiece stack-up assembly that includes dissimilar metal workpieces involves melting a portion of a top metal workpiece that overlies an underlying metal workpiece and covers at least one intruding hollow feature defined in the underlying metal workpiece. The molten material of the top metal workpiece flows into the at least one intruding feature defined in the underlying metal workpiece and, upon solidification therein, establishes a weld joint that metallurgically secures the top and underlying metal workpieces together. The top metal workpiece comprises a base metal substrate and the underlying metal workpiece comprises a base metal substrate. The base metal substrate of the top metal workpiece is different than the base metal substrate of the underlying metal workpiece and has a melting point that is less than a melting point of the base metal substrate of the underlying metal workpiece.

### INTRODUCTION

Laser welding is a metal joining process that relies on a laser beam to provide the heat needed to join together an assembly of stacked-up metal workpieces. Laser welding has long been employed to fusion weld together similarly-composed metal workpieces. In general, complimentary flanges or other bonding regions of two or more similarly-composed metal workpieces are first aligned, fitted, and stacked relative to one another such that their faying surfaces overlap and confront to establish one or more faying interfaces. A laser beam is then directed at an accessible top surface of the workpiece stack-up within a welding region spanned by the overlapping portion of the meal workpieces. The heat generated from the absorption of energy from the laser beam initiates melting of the metal workpieces and establishes a molten metal weld pool within the workpiece stack-up. The molten metal weld pool penetrates into the stack-up and intersects at least one, and usually all, of the established faying interfaces. And, if the power density of the laser beam is high enough, a keyhole is produced beneath a beam spot of the laser beam within the molten metal weld pool. A keyhole is a column of vaporized metal, which may include plasma, derived from the metal workpieces. The keyhole is an effective absorber of energy from the laser beam, thus allowing for deep and narrow penetration of molten workpiece metal into the stack-up.

The molten metal weld pool and, if present, the keyhole, are created in very short order once the laser beam impinges the top surface of the workpiece stack-up. After the metal workpieces are initially melted, the beam spot of the laser beam may be advanced relative to the top surface of the workpiece stack-up, which may involve moving the laser beam along a beam travel pattern of a relatively simple geometrical profile as projected onto the top surface of the stack-up. As the laser beam is advanced along the top surface of the stack-up, molten workpiece metal from the molten metal weld pool flows around and behind the advancing beam spot within the workpiece stack-up. This penetrating molten workpiece metal quickly cools and solidifies in the wake of the advancing laser beam into resolidified metal workpiece material. The transmission of the laser beam at the top surface of the workpiece stack-up is eventually ceased once the laser beam has finished tracking the beam travel pattern, at which time the keyhole collapses, if present, and any molten workpiece metal still remaining within the stack-up solidifies. The collective resolidified workpiece material obtained by operation of the laser beam constitutes a laser weld joint that autogenously fusion welds the overlapping metal workpieces together.

Laser welding is an attractive joining process because it requires only single side access, can be practiced with reduced flange widths, and results in a relatively small heat-affected zone within the stack-up assembly that minimizes thermal distortion in the metal workpieces. For that reason, a number of industries use laser welding as part of their manufacturing practice including, but not limited to, the automotive, aviation, maritime, railway, and building construction industries. In the automotive industry, for example, laser welding can be used to join together metal workpieces during the manufacture of the body-in-white (BIW) as well as finished hang-on parts that are installed on the BIW prior to painting. Some specific instances where laser welding may be used include the construction and attachment of load-bearing body structures within the BIW such as rail structures, rockers, A-, B-, and C-pillars, and underbody cross-members. Other specific instances where laser welding may also be used include non-load-bearing attachments within the BIW, such as the attachment of a roof to a side panel, and to join overlying flanges encountered in the construction of the doors, hood, and trunk.

Recently, however, and particularly in the automotive industry, there has been growing interest in joining together dissimilar metal workpieces so that certain metals can be more appropriately apportioned within the product being manufactured based on utility of the individual metals. By way of example, the manufacture of an automobile BIW may call for the use of steel in areas where strength is needed, but may also seek to incorporate aluminum in areas where lighter-weight metals are just as acceptable. Aluminum and steel workpieces may therefore have to be joined at various locations throughout the BIW. Laser welding of dissimilar metal workpieces presents a multitude of challenges since the workpieces will inevitably have different compositions and different properties such as melting points and thermal conductivities. Additionally, in the event that both metal workpieces can actually be melted by a laser beam in an orderly fashion, the commingling of disparate molten metal material from each of the dissimilar metal workpieces may lead to the large-scale formation of brittle intermetallics that have the potential to severely weaken the resultant laser weld joint.

Given the metallurgical and practical challenges involved in joining together dissimilar metal workpieces with a heat source such as a laser beam, product manufactures have predominantly relied on mechanical fasteners such as self-piercing rivets and flow-drill screws to accomplish the necessary joining. Mechanical fasteners, however, take longer to put in place and have high consumable costs compared to laser welding. They also add weight to the vehicle—weight that is avoided when joining is accomplished by way of laser welding—that can offset some of the weight savings attained through the use of dissimilar metal workpieces in the first place. Still further, mechanical fasteners require additional manufacturing equipment and floor space allocations that could possibly be avoided if the dissimilar metal workpieces could be joined by existing laser welding equipment. Advancements in laser welding that would make it easier to join dissimilar metal workpieces would thus be a welcome addition to the art.

### SUMMARY

A method of welding a workpiece stack-up assembly that includes dissimilar metal workpieces according to one embodiment of the present disclosure may include several steps. In one step, a workpiece stack-up assembly is provided that includes a top metal workpiece and an underlying metal workpiece that overlap to define an overlapping welding region. The top metal workpiece overlies the underlying metal workpiece and covers at least one intruding hollow feature defined in the underlying metal workpiece. The top metal workpiece comprises a base metal substrate and the underlying metal workpiece comprises a base metal substrate. The base metal substrate of the top metal workpiece is different than the base metal substrate of the underlying metal workpiece and has a melting point that is less than a melting point of the base metal substrate of the underlying metal workpiece. In another step, a portion of the top metal workpiece is melted with a concentrated heat source to create molten metal material of the top metal workpiece that flows into the at least one intruding hollow feature defined in the underlying workpiece. In another step, the molten metal material of the top metal workpiece is allowed to solidify in the at least one intruding hollow feature defined in the underlying workpiece to establish a weld joint that metallurgically secures the top metal workpiece and the underlying metal workpiece together.

The method of the aforementioned embodiment may include additional steps or be further defined. For example, the step of providing the workpiece stack-up assembly may include forming the at least one intruding hollow feature in the underlying metal workpiece and assembling the top metal workpiece and the underlying metal workpiece into the workpiece stack-up assembly. The at least one intruding hollow feature may be formed by directing a laser beam at the underlying metal workpiece to melt and remove material from the underlying metal workpiece. As another example, the step of melting the portion of the top metal workpiece with the concentrated heat source may include directing a laser beam at an accessible outer surface of the top metal workpiece and training a beam spot of the laser beam at the accessible outer surface or advancing the beam spot relative to the accessible outer surface along a beam travel pattern to melt the portion of the top metal workpiece. The directing of the laser beam at the accessible outer surface of the top metal workpiece may comprise operating a scanning optic laser head to direct the laser beam at the accessible outer surface of the top metal workpiece with the laser beam having a focal length that ranges from 0.4 meters to 2.0 meters.

The intruding hollow features formed in the underlying metal workpiece may take on any of a variety of shapes and sizes in the method of the aforementioned embodiment. In one implementation, the intruding hollow feature may be a through hole that fully traverses a thickness of the underlying metal workpiece. The through hole may be defined by an interior surface of the underlying metal workpiece. The interior surface of the underlying metal workpiece may be serrated such that the interior surface that defines the through hole includes one or more notches that are axially spaced apart and extend at least partially along a circumference of the interior surface. In another implementation, the intruding hollow feature may be a cavity that is open to an adjacent faying surface of the top metal workpiece and only partially traverses a thickness of the underlying metal workpiece. The cavity may be defined by an interior surface of the underlying metal workpiece. The interior surface of the underlying metal workpiece may be serrated such that the interior surface that defines the cavity includes one or more notches that are axially spaced apart and extend at least partially along a circumference of the interior surface.

The workpiece stack-up assembly of the method of the aforementioned embodiment may include at least one additional metal workpiece besides the top and underlying metal workpieces. For instance, in one implementation, the workpiece stack-up assembly may include a first underlying metal workpiece and a second underlying metal workpiece. To that end, the top metal workpiece overlies the first underlying metal workpiece, and the first underlying metal workpiece overlies the second underlying metal workpiece. The first underlying metal workpiece defines at least one intruding hollow feature that fully traverses a thickness of the first underlying metal workpiece and communicates with at least one intruding hollow feature defined in the second underlying metal workpiece. The molten metal material of the top metal workpiece thus flows into and through the at least one intruding hollow feature defined in the first underlying metal workpiece also into the at least one intruding hollow feature defined in the second underlying metal workpiece. Moreover, the intruding hollow feature defined in the second underlying metal workpiece may be a cavity that is open at to an adjacent faying surface of the first underlying metal workpiece and only partially traverses a thickness of the second underlying metal workpiece. The cavity may be defined by an interior surface of the second underlying metal workpiece. The interior surface may be serrated such that the interior surface that defines the cavity includes one or more notches that are axially spaced apart and extend at least partially along a circumference of the interior surface.

Other variations of the method of the aforementioned embodiment are certainly possible. For example, the top metal workpiece may be an aluminum workpiece and the underlying metal workpiece may be a steel workpiece. As another example, the at least one intruding hollow feature may comprise a plurality of intruding hollow features. Other variations not specifically mentioned here may also be possible.

A method of welding a workpiece stack-up assembly that includes dissimilar metal workpieces according to another embodiment of the present disclosure may include several steps. In one step, at least one intruding hollow feature may be formed in a steel workpiece. In another step, an aluminum workpiece and the steel workpiece may be assembled into a workpiece stack-up assembly in which the aluminum workpiece overlaps the steel workpiece and covers the at least one intruding hollow feature defined in the steel workpiece. In still another step, a portion of the aluminum workpiece is melted with a laser beam to create molten aluminum material that flows into the at least one intruding hollow feature defined in the steel workpiece. In another step, the molten aluminum material is allowed to solidify in the at least one intruding hollow feature defined in the steel workpiece to establish a weld joint that secures the aluminum workpiece and the steel workpiece together.

The method of the aforementioned embodiment may include additional steps or be further defined. For example, the intruding hollow feature may be a through hole that fully traverses a thickness of the steel workpiece, or it may be a cavity that is open to an adjacent faying surface of the aluminum workpiece an only partially traverses a thickness of the steel workpiece. In either case, the interior surface of the steel workpiece the defines the intruding hollow feature may be serrated. In another example, the step of melting the portion of the aluminum workpiece with the laser beam may include directing the laser beam at an accessible outer surface of the aluminum workpiece from a scanning optic laser head of a remote laser welding apparatus with the laser beam having a focal length that ranges from 0.4 meters to 2.0 meters, and training a beam spot of the laser beam at the accessible outer surface or advancing the beam spot relative to the accessible outer surface along a beam travel pattern to melt the portion of the aluminum workpiece. In yet another example, the method may further include positioning a filler wire relative to the laser beam so that the filler wire is impinged by the laser beam to melt the filler wire and introduce molten filler material into the molten aluminum material.

The workpiece stack-up assembly of the method of the aforementioned embodiment may include at least one additional metal workpiece besides the top and underlying metal workpieces. For instance, the step of assembling the the aluminum workpiece and the steel workpiece into the workpiece stack-up assembly may include assembling the aluminum workpiece, the steel workpiece, and an additional aluminum workpiece into the workpiece stack-up. The aluminum workpiece overlaps the steel workpiece and covers the at least one intruding hollow feature defined in the steel workpiece, which fully traverses a thickness of the steel workpiece, and the steel workpiece overlaps the additional aluminum workpiece such that the at least one intruding hollow feature defined in the steel workpiece communicates with at least one intruding hollow feature defined in the additional aluminum workpiece.

### BRIEF DESCRIPTION OF THE DRAWINGS

FIG. 1 is a general illustration of a workpiece stack-up assembly that includes overlapping dissimilar metal workpieces along with a remote laser welding apparatus that can carry out the disclosed method of j oining together the overlapping dissimilar metal workpieces according to one embodiment of the present disclosure;

FIG. 2 is a cross-sectional view of the underlying metal workpiece of the workpiece stack-up assembly shown in FIG. 1 during formation of an intruding hollow feature within the underlying metal workpiece according to one embodiment of the present disclosure;

FIG. 3 is a cross-sectional view of the workpiece stack-up assembly shown in FIG. 1 in which the top metal workpiece is superimposed over the underlying metal workpiece to cover the intruding hollow feature defined in the underlying metal workpiece according to one embodiment of the present disclosure;

FIG. 4 a cross-sectional view of the workpiece stack-up assembly shown in FIG. 1 in which a laser beam (referred to herein as a welding laser beam) transmitted by the remote laser welding apparatus is serving as a heat source that melts the top metal workpiece so that molten metal material from the top metal workpiece flows into the intruding hollow feature defined in the underlying metal workpiece to ultimately lead to a weld joint that secures the two metal workpieces together according to one embodiment of the present disclosure;

FIG. 5 is a cross-sectional view of another embodiment of the intruding hollow feature that may be formed within the underlying metal workpiece according to one embodiment of the present disclosure;

FIG. 6 is a cross-sectional view of a workpiece stack-up assembly that includes the underlying metal workpiece shown in FIG. 5 as well as a laser beam (referred to herein as a welding laser beam) being transmitted by the remote laser welding apparatus to serve as a heat source that melts the top metal workpiece so that molten metal material from the top metal workpiece flows into the intruding hollow feature defined in the underlying metal workpiece to ultimately lead to a weld joint that secures the two metal workpieces together according to one embodiment of the present disclosure;

FIG. 7 is a cross-sectional view of another embodiment of the intruding hollow feature that may be formed within the underlying metal workpiece according to one embodiment of the present disclosure;

FIG. 8 is a cross-sectional view of a workpiece stack-up assembly that includes the underlying metal workpiece shown in FIG. 7 as well as a laser beam (referred to herein as a welding laser beam) being transmitted by the remote laser welding apparatus to serve as a heat source that melts the top metal workpiece so that molten metal material from the top metal workpiece flows into the intruding hollow feature defined in the underlying metal workpiece to ultimately lead to a weld joint that secures the two metal workpieces together according to one embodiment of the present disclosure;

FIG. 9 is a plan view depicting a plurality of intruding hollow features that may be formed within the underlying metal workpiece according to one embodiment of the present disclosure;

FIG. 10 is a plan view depicting a plurality of intruding hollow features that may be formed within the underlying metal workpiece according to another embodiment of the present disclosure;

FIG. 11 is a plan view depicting a plurality of intruding hollow features that may be formed within the underlying metal workpiece according to still another embodiment of the present disclosure;

FIG. 12 is a cross-sectional view of a workpiece stack-up assembly in which the top metal workpiece is superimposed over a first underlying metal workpiece and a second underlying metal workpiece, which underlies the first underlying metal workpiece, to cover an intruding hollow feature defined in the first underlying metal workpiece that fully traverses a thickness of the underlying metal workpiece and communicates with an intruding hollow feature defined in the second underlying metal workpiece according to one embodiment of the present disclosure; and

FIG. 13 a cross-sectional view of the workpiece stack-up assembly shown in FIG. 12 in which a laser beam (referred to herein as a welding laser beam) transmitted by the remote laser welding apparatus is serving as a heat source that melts the top metal workpiece so that molten metal material from the top metal workpiece flows into and through the intruding hollow feature defined in the first underlying metal workpiece and then into the intruding hollow feature defined in the second underlying metal workpiece to ultimately lead to a weld joint that secures the three metal workpieces together according to one embodiment of the present disclosure.

### DETAILED DESCRIPTION

A method of joining together dissimilar metal workpieces involves assembling a workpiece stack-up assembly that includes at least a top metal workpiece and an underlying metal workpiece in which the top metal workpiece comprises a base metal substrate and the underlying metal workpiece comprises a base metal substrate that is different from the base metal substrate of the top metal workpiece. Additionally, the base metal substrate of the top metal workpiece has a lower melting point than the base metal substrate of the underlying metal workpiece. The top metal workpiece and the underlying metal workpiece overlap to define an an overlapping welding region and, within the overlapping welding region, the top metal workpiece covers at least one intruding hollow feature defined in the underlying metal workpiece. A concentrated heat source is then directed at the top metal workpiece to melt a portion of the top metal workpiece above the at least one intruding hollow feature defined in the underlying metal workpiece to create molten metal material. The molten metal material of the top metal workpiece flows into the at least one intruding hollow feature defined in the underlying metal workpiece. This infiltrating flow of molten metal material is eventually allowed to solidify in the at least one intruding hollow feature—typically by halting or relocating the concentrated heat source—to establish a weld joint that metallurgically secures the top and underlying metal workpieces together.

The concentrated heat source employed to melt the top metal workpiece may take on a variety of forms including a laser beam or an electron beam. Preferably, however, the concentrated heat source is a laser beam. Any type of laser welding apparatus may be used to transmit the laser beam including, for example, a remote laser welding apparatus or a conventional laser welding apparatus. The transmitted laser beam may be a solid-state laser beam or a gas laser beam depending on the characteristics of the metal workpieces being joined and the laser welding mode (conduction, keyhole, etc.) desired to be practiced. Some notable solid-state lasers that may be used are a fiber laser, a disk laser, a direct diode laser, and a Nd:YAG laser, and a notable gas laser that may be used is a CO2 laser, although other types of lasers may certainly be used. In a preferred implementation of the disclosed method, which is described below in more detail, a remote laser welding apparatus is employed melt the portion of the top metal workpiece as needed to cause molten metal material from the top metal workpiece to flow into the at least one intruding hollow feature defined within the underlying metal workpiece. The remote laser welding apparatus may also be used to form the at least one intruding hollow features, if desired.

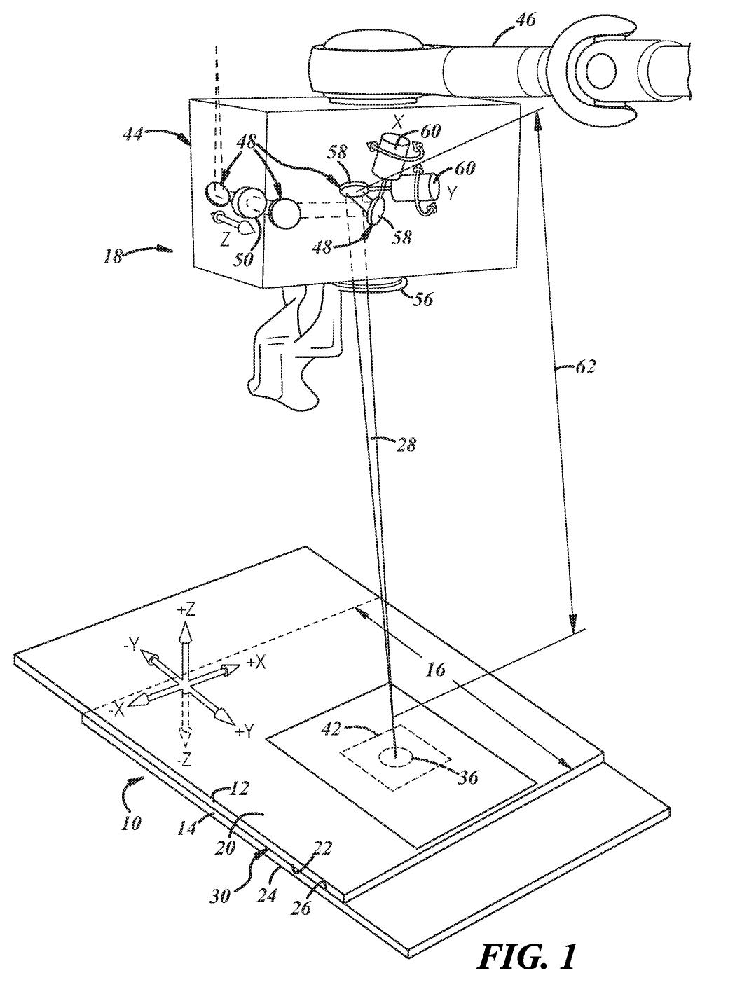

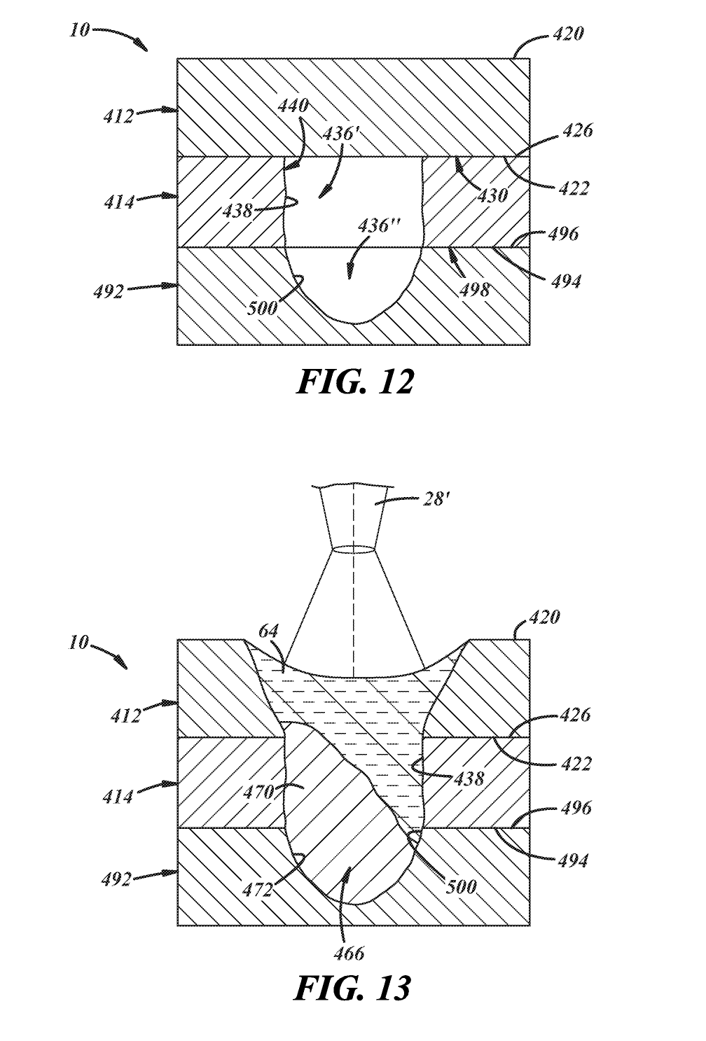

The disclosed method of joining together dissimilar metal workpieces can be performed on a variety of workpiece stack-up assembly configurations. For example, the disclosed method may be used in conjunction with a workpiece stack-up assembly that includes two dissimilar metal workpieces (e.g., FIGS. 1-10), or it may be used in conjunction with a workpiece stack-up assembly that includes at least one additional metal workpiece—besides the top metal workpiece and the underlying metal workpiece—that underlies the top metal workpiece (e.g., FIGS. 12-13). The types and combinations of the metal workpieces that may be included within the workpiece stack-up assembly may also vary. As one example, the top metal workpiece may be an aluminum workpiece that includes a base aluminum substrate (melting point of approximately 570° C. to 600° C.) and the underlying metal workpiece may be a steel workpiece that includes a base steel substrate (melting point of approximately 1300° C. to 1500° C.). And, in addition to those two metal workpieces (Al-steel), the additional metal workpiece, if present, may be another aluminum workpiece although other workpieces may also be used. The disclosed method is carried out in essentially the same way to achieve the same results regardless of whether the workpiece stack-up assembly includes two overlapping metal workpieces or more than two overlapping metal workpieces. Any differences in workpiece stack-up assembly configurations can be easily accommodated by adjusting the characteristics of the employed laser beam or other concentrated heat source.

Referring now to FIGS. 1-4, a method of joining overlapping dissimilar metal workpieces included in a workpiece stack-up assembly 10 is shown. The workpiece stack-up assembly 10 includes a top metal workpiece 12 and an underlying metal workpiece 14 that overlap to define an overlapping welding region 16. A remote laser welding apparatus 18 that can perform the disclosed joining method is also shown. Within the overlapping welding region 16 of this particular embodiment of the workpiece stack-up assembly 10, the top metal workpiece 12 includes an accessible outer surface 20 and a faying surface 22 and, likewise, the underlying metal workpiece 14 includes an accessible outer surface 24 and a faying surface 26. The accessible outer surface 20 of the top metal workpiece 12 is made available to the remote laser welding apparatus 18 and is accessible by a laser beam 28 emanating from the remote laser welding apparatus 18. And since only single side access is needed to conduct laser welding, there is no need for the accessible outer surface 24 of the underlying metal workpiece 14 to be made accessible in the same way. The terms “top metal workpiece” and “underlying metal workpiece” as used herein are relative designations that identify within the two overalapping dissimilar metal workpieces 12, 14 the workpiece that is more proximate to the remote laser welding apparatus 18 (top) and the workpiece that is beneath that “top” metal workpiece and more distal from the laser welding apparatus 18 (underlying).

The faying surfaces 22, 26 of the top and underlying metal workpieces 12, 14 confront within the overlapping welding region 16 to establish a faying interface 30. The term “faying interface” is used broadly in the present disclosure and encompasses a wide range of overlapping relationships between the confronting and faying surfaces 22, 26 of the metal workpieces 12, 14 that can accommodate the practice of laser welding. For instance, the faying surfaces 22, 26 may establish the faying interface 30 by being in direct or indirect contact. The faying surfaces 22, 26 are in direct contact with each other when they physically abut and are not separated by a discrete intervening material layer or gaps that fall outside of normal assembly tolerance ranges. The faying surfaces 22, 26 are in indirect contact when they are separated by a discrete intervening material layer such as a sealer or adhesive—and thus do not experience the type of interfacial abutment that typifies direct contact—yet are in close enough proximity that laser welding can be practiced. As another example, the faying surfaces 22, 26 may establish the faying interface 30 by being separated by imposed gaps. Such gaps may be imposed between the faying surfaces 22, 26 by creating protruding features on one or both of the faying surfaces 22, 26 through laser scoring, mechanical dimpling, or otherwise. The protruding features maintain intermittent contact points between the faying surfaces 22, 26 that keep the surfaces 22, 26 spaced apart outside of and around the contact points by up to 1.0 mm.

As shown best in FIG. 3, the top metal workpiece 12 includes a base metal substrate 32 and the underlying metal workpiece 14 includes a base metal substrate 34 that is different than the base metal substrate 32 of the top metal workpiece 12. The base metal substrate 32 of the top metal workpiece 12 has a melting point that is less than a melting point of the base metal substrate 34 of the underlying metal workpiece 14. Each of the base metal substrates 32, 34 may be coated or bare (i.e., uncoated) as will be further described below. The surface coating(s) may be employed on one or both of the base metal substrates 32, 34 for various reasons including corrosion protection, strength enhancement, and/or to improve processing, among other reasons, and the composition of the surface coating(s) is based largely on the composition of the associated base metal substrates 32, 34. Taking into the account the thicknesses of the base metal substrates 32, 34 and their optional surface coatings, a thickness 121 of the top metal workpiece 12 preferably ranges from 1.0 mm to 4.0 mm and a thickness 141 of the underlying metal workpiece 14 preferably ranges from 0.5 mm to 3.0 mm at least within the overlapping welding region 16. The thicknesses 121, 141 of the top and underlying metal workpieces 12, 14 may be the same or different from each other.

In one embodiment, the top metal workpiece is an aluminum workpiece and the underlying metal workpiece is a steel workpiece. In that regard, the base metal substrate 32 of the top metal (aluminum) workpiece 12 is a base aluminum substrate that is composed of unalloyed aluminum or an aluminum alloy that includes at least 85 wt % aluminum. Some notable aluminum alloys that may constitute the base aluminum substrate are an aluminum-magnesium alloy, an aluminum-silicon alloy, an aluminum-magnesium-silicon alloy, or an aluminum-zinc alloy. Additionally, the base aluminum substrate may be provided in wrought or cast form. For example, the base aluminum substrate may be composed of a 4xxx, 5xxx, 6xxx, or 7xxx series wrought aluminum alloy sheet layer, extrusion, forging, or other worked article, or a 4xx.x, 5xx.x, or 7xx.x series aluminum alloy casting. Some more specific kinds of aluminum alloys that can be used as the base aluminum substrate include AA5182 and AA5754 aluminum-magnesium alloy, AA6011 and AA6022 aluminum-magnesium-silicon alloy, AA7003 and AA7055 aluminum-zinc alloy, and Al-10Si-Mg aluminum die casting alloy. The base aluminum substrate may be employed in a variety of tempers including annealed (O), strain hardened (H), and solution heat treated (T).

The base aluminum substrate may include any of a number of surface coatings as part of the aluminum workpiece. If present, the surface coating that covers the base aluminum substrate may be a refractory oxide coating comprised of aluminum oxide compounds such as a native oxide layer that forms passively when fresh aluminum is exposed to atmospheric air or some other oxygen-containing medium and/or during manufacturing operations (e.g., mill scale) or otherwise. The surface coating may also be a metallic coating comprised of zinc or tin, or it may be a metal oxide conversion coating comprised of oxides of titanium, zirconium, chromium, or silicon as disclosed in U.S. Patent Application No. US2014/0360986. A typical thickness of the surface coating, if present, lies anywhere from 1 nm to 10 μm depending on the composition of the surface coating and the manner in which the coating is derived, although other thicknesses may be possible. Passively formed refractory oxide coatings, for example, often have thicknesses that range from 2 nm to 10 nm when the underlying base aluminum substrate is an aluminum alloy.

The base metal substrate 34 of the underlying metal (steel) workpiece 14 may be composed of any of a wide variety of steels including low-carbon (mild) steel, interstitial-free (IF) steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel workpiece includes press-hardened steel (PHS). Preferred compositions of the base steel substrate, however, include mild steel, dual phase steel, and boron steel used in the manufacture of press-hardened steel. Those three types of steel have ultimate tensile strengths that, respectively, may range from 150 MPa to 500 MPa, from 500 MPa to 1100 MPa, and from 1200 MPa to 1800 MPa. Moreover, the base steel substrate may have been treated to obtain a particular set of mechanical properties, including being subjected to heat-treatment processes such as annealing, quenching, and/or tempering. The base steel substrate may be hot or cold rolled to its final thicknesses.

The base steel substrate may include any of a number of surface coatings as part of the steel substrate. If present, the surface coating that covers the base steel substrate may be a zinc-based material or an aluminum-based material. Some examples of a zinc-based material include zinc or a zinc alloy such as a zinc-nickel alloy or a zinc-iron alloy. A coating of a zinc-based material may be applied by hot-dip galvanizing (hot-dip galvanized zinc coating), electrogalvanizing (electrogalvanized zinc coating), electrodeposition (electrodeposited zinc, zinc-iron alloy, or zinc-nickel alloy), or galvannealing (galvanneal zinc-iron alloy), typically to a thickness of between 2 μm to 50 μm, although other procedures and thicknesses of the attained surface coating may be employed. Some examples of a suitable aluminum-based material include aluminum, an aluminum-silicon alloy, an aluminum-zinc alloy, and an aluminum-magnesium alloy. A coating of an aluminum-based material may be applied by dip coating, typically to a thickness of 2 μm to 30 μm, although other coating procedures and thicknesses of the attained coating(s) may be employed.

The underlying metal workpiece 14 defines at least one intruding hollow feature 36 that is covered by the top metal workpiece 12 and, in particular, the faying surface 22 of the top metal workpiece 12, within the overlapping welding region 16. The intruding hollow feature 36 is defined by an interior surface 38 of the underlying metal workpiece 14. In one implementation, as shown in FIGS. 1-4, the intruding hollow feature 36 is a through hole 40 that fully traverses the thickness 141 of the underlying metal workpiece 14; that is, the through hole 40 extends between and is open at each of its accessible outer and faying surfaces 24, 26. The size of the through hole 40 is subject to variation based on a number of factors including the thicknesses 121, 141 of the top and underlying metal workpieces 12, 14 and whether or not only a single through hole 40 is present or other intruding hollow features 36 of the same or different size and shape are present and grouped together. For instance, if only a single through hole 40 is present, as shown here in FIGS. 1-4, an average diameter 401 of the through hole 40 may range from 2.0 mm to 15.0 mm or, more narrowly, from 5.0 mm to 10.0 mm. If, on the other hand, multiple through holes 40 are present and grouped together, the average diameter 401 of each of the through holes 40 may range from 0.5 mm to 5.0 mm or, more narrowly, from 1.0 mm to 3.0 mm. If multiple through holes 40 are present, anywhere from three to fifteen through holes 40 are preferably grouped together and contained within a surface area 42 (FIG. 1) that spans between 15 mm² to 400 mm² on the faying surface 26 of the underlying metal workpiece 14.

Referring back to FIG. 1, the remote laser welding apparatus 18 includes a scanning optic laser head 44. Generally speaking, and with reference for the moment to the workpiece stack-up assembly 10, the scanning optic laser head 44 directs the transmission of the laser beam 28 towards the accessible outer surface 20 of the top metal workpiece 12. The directed laser beam 28 has a beam spot 281, which is the sectional area of the laser beam 28 at a plane oriented along the accessible outer surface 20 of the top metal workpiece 12, as shown best in FIG. 3. The scanning optic laser head 44 is preferably mounted to a robotic arm 46 (partially shown) that can rapidly and accurately carry the laser head 44 in three-dimensional space above the accessible outer surface 20 of the top metal workpiece 12 according to programmed instructions. The laser beam 28 used in conjunction with the scanning optic laser head 44 is preferably a solid-state laser beam operating with a wavelength in the near-infrared range (commonly considered to be 700 nm to 1400 nm) of the electromagnetic spectrum. Additionally, the laser beam 28 has a power level capability that can attain a power density sufficient to produce a keyhole, if desired, within the top metal workpiece 12 during performance of the joining method. The power density needed to produce a keyhole within the top metal workpiece 12 may range from 0.5 MW/cm² to 1.5 MW/cm², depending on the composition of the base metal substrate 32.

Some examples of a suitable solid-state laser beam that may be used in conjunction with the remote laser welding apparatus 18 include a fiber laser beam, a disk laser beam, and a direct diode laser beam. A preferred fiber laser beam is a diode-pumped laser beam in which the laser gain medium is an optical fiber doped with a rare earth element (e.g., erbium, ytterbium, neodymium, dysprosium, praseodymium, thulium, etc.). A preferred disk laser beam is a diode-pumped laser beam in which the gain medium is a thin laser crystal disk doped with a rare earth element (e.g., a ytterbium-doped yttrium-aluminum garnet (Yb:YAG) crystal coated with a reflective surface) and mounted to a heat sink. And a preferred direct diode laser beam is a combined laser beam (e.g., wavelength combined) derived from multiple diodes in which the gain medium is multiple semiconductors such as those based on aluminum gallium arsenide (AlGaAS) or indium gallium arsenide (InGaAS). Laser generators that can generate each of those types of lasers as well as other variations are commercially available. Other solid-state laser beams not specifically mentioned here may of course be used.

The scanning optic laser head 44 includes an arrangement of mirrors 48 that can maneuver the laser beam 28 and thus convey the beam spot 281 along the accessible outer surface 20 of the top metal workpiece 12 within an operating envelope that at least partially encompasses the overlapping welding region 16. Here, as illustrated in FIG. 1, the position of the beam spot 281 on the accessible outer surface 20 of the top metal workpiece 12 within the operating envelope is identified by the “x” and “y” coordinates of a three-dimensional coordinate system. In addition to the arrangement of mirrors 48, the scanning optic laser head 44 also includes a z-axis focal lens 50, which can move a focal point or waist 52 (FIG. 3) of the laser beam 28 along a longitudinal axis 54 of the laser beam 28 to thus vary the location of the focal point 52 in a z-direction of the same three-dimensional coordinate system. Furthermore, to keep dirt and debris from adversely affecting the optical system components and the integrity of the laser beam 28, a cover slide 56 may be situated below the scanning optic laser head 44. The cover slide 56 protects the arrangement of mirrors 46 and the z-axis focal lens 50 from the surrounding environment yet allows the laser beam 28 to pass out of the scanning optic laser head 44 without substantial disruption.

The arrangement of mirrors 48 and the z-axis focal lens 50 cooperate during operation of the remote laser welding apparatus 18 to dictate the desired movement of the laser beam 28 and its beam spot 281 within the operating envelope as well as the position of the focal point 52 along the longitudinal axis 54 of the beam 28, if indeed such movement is needed. The arrangement of mirrors 48, more specifically, includes a pair of tiltable scanning mirrors 58. Each of the tiltable scanning mirrors 58 is mounted on a galvanometer 60. The two tiltable scanning mirrors 58 can move the location of the beam spot 281—and thus change the point at which the laser beam 28 intersects the accessible outer surface 20 of the top metal workpiece 12—relative to the x-y plane of the operating envelope through precise coordinated tilting movements executed by the galvanometers 60. At the same time, the z-axis focal lens 50 controls the location of the focal point 52 of the laser beam 28 in order to help administer the laser beam 28 at the correct power density. All of these optical components 50, 58 can be rapidly indexed in a matter of milliseconds or less to advance the beam spot 281 of the laser beam 28 relative to the accessible outer surface 20 of the top metal workpiece 12 along a beam travel pattern of simple or complex geometry as projected onto the accessible outer surface 20 of the top metal workpieces 12, if desired, while controlling the location of the focal point 52.

A characteristic that differentiates remote laser welding from other conventional forms of laser welding is the focal length of the laser beam 28. Here, as shown in FIG. 1, the laser beam 28 has a focal length 62, which is measured as the distance between the focal point 52 and the last tiltable scanning mirror 58 that intercepts and reflects the laser beam 28 prior to the laser beam 28 exiting the scanning optic laser head 44. The focal length 62 of the laser beam 28 is preferably in the range of 0.4 meters to 2.0 meters with a diameter of the focal point 52 typically ranging anywhere from 100 μm to 700 μm. The focal length 62 can be easily adjusted by changing the position of the z-axis focal lens 52. By comparison, in conventional laser welding in which a diverging laser beam is collimated and then focused through a lens or mirror(s) towards a workpiece stack-up assembly, the focal length of the laser beam generally ranges anywhere from 100 mm to 400 mm or, more narrowly, from 200 mm to 300 mm with a diameter of the focal point typically ranging anywhere from 0.5 mm to 4.0 mm.

Referring still to FIGS. 1-4, the top metal workpiece 12 and the underlying metal workpiece 14 may be joined by using the laser beam 28 as a concentrated heat source to melt a portion of the top metal workpiece 12 to create molten metal material 64 from the top metal workpiece 12 (FIG. 4) that flows into and eventually solidifies within the at least one intruding hollow feature 36 defined within the underlying metal workpiece 14. In particular, the joining method involves first providing the workpiece stack-up assembly 10. Once the stack-up assembly 10 is provided, the top metal workpiece 12 is melted with a welding laser beam 28′ transmitted by the remote laser welding apparatus 18 and directed at the accessible outer surface 20 of the top metal workpiece 12. The molten metal material 64 created by melting the top metal workpiece 12 and that flows into the at least one intruding hollow feature 36 defined by the underlying metal workpiece 14 is then allowed to solidify into a weld joint 66 that metallurgically secures the top and underlying metal workpieces 12, 14 together. The term “welding laser beam” is used herein to refer specifically to the laser beam 28 emanating from the remote laser welding apparatus 18 when that laser beam 28 is being used to melt a portion of the top metal workpiece 12 to create the molten metal material 64 that infiltrates the at least one intruding hollow feature 36.

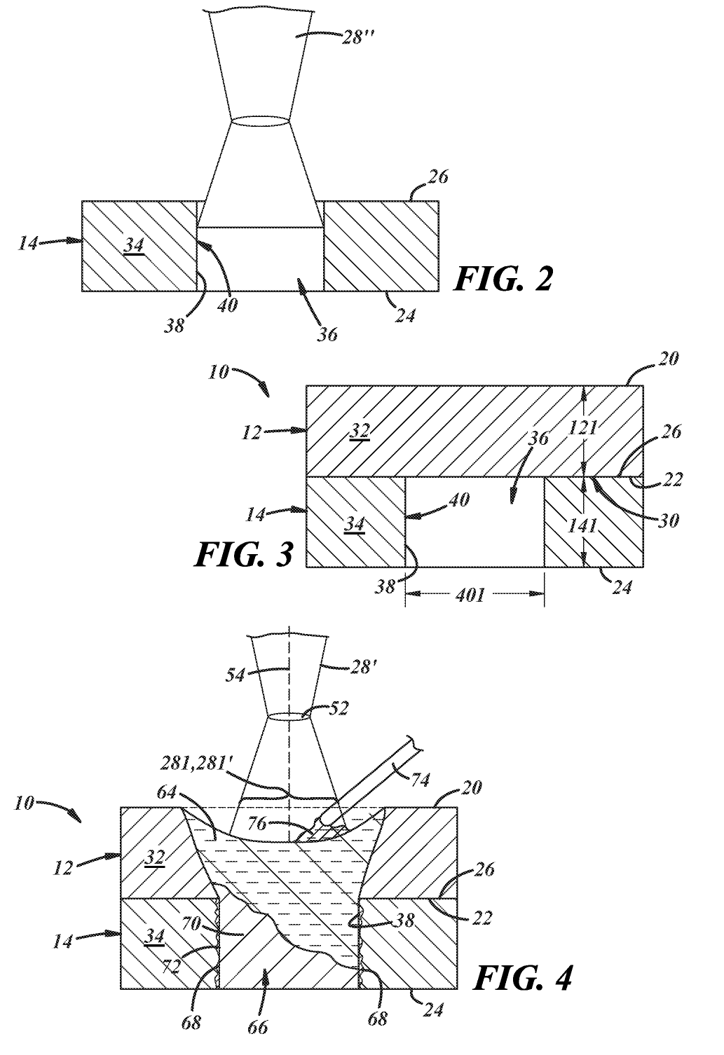

The workpiece stack-up assembly 10 may be provided by, first, forming the at least one intruding hollow feature 36 (shown as through holes 40 in this particular embodiment) in the underlying metal workpiece 14 and then assembling the underlying metal workpiece 14 and the top metal workpiece 12 into the stack-up assembly 10. The at least one through hole 40 may be formed in a number of ways. In one approach, for example, a forming laser beam 28″ transmitted by the remote laser welding apparatus 18 may be directed at the underlying metal workpiece 14, as shown in FIG. 2, to produce each of the through holes 40 prior to the underlying metal workpiece 14 being assembled into the workpiece stack-up assembly 10. Specifically, at each location where a through hole 40 is desired, the forming laser beam 28″ is directed at and impinges either the accessible outer surface 24 or the faying surface 26 to melt through the metal workpiece 14 and to expel the resultant material such that the through hole 40 is defined in the underlying metal workpiece 14. The power density, beam transmission time, and/or the movement of the beam spot of the forming laser beam 28″ can be easily tailored to form the through hole(s) 40. The term “forming laser beam” is used herein to refer specifically to the laser beam 28 emanating from the remote laser welding apparatus 18 when the laser beam 28 is being used to form the at least one intruding hollow feature 36 in the underlying metal workpiece 14.

The terms “welding laser beam” and “forming laser beam” are thus used to differentiate between the use of the laser beam 28 transmitted by the remote laser welding apparatus 18 within the joining method. To that end, the designation of the laser beams as “the welding laser beam” and “the forming laser beam” along with their respective reference numeral designations 28′, 28″ is not necessarily intended to indicate a difference in laser beam type—although such distinctions are not foreclosed in other alternative embodiments where the welding laser beam and forming laser beam are transmitted from different remote laser welding apparatus—but rather is meant to differentiate between the use of the laser beam 28 at different times of the overall joining method as well as to differentiate between its functions (i.e., form the at least one intruding hollow feature vs melt the top metal workpiece during establishment of the weld joint) within the overall joining method. The laser beam identified by reference numeral 28 is thus indicative of how each of the welding laser beam 28′ and the forming laser beam 28″ is delivered and potentially maneuvered by the remote laser welding apparatus 18.

The through hole(s) 40 may be formed by other techniques besides the use of the forming laser beam 28″. For instance, in another suitable approach, each of the through holes 40 may be formed within the underlying metal workpiece 14 by mechanical techniques such as drilling or screwing. In particular, at each location where a through hole 40 is desired, a rotating drill bit or a rotating screw may be driven through the underlying metal workpiece 14 from the accessible outer surface 24 to the faying surface 26, or vice versa, to remove material such that the through hole 40 is defined in the underlying metal workpiece 14. In still other approaches, the through hole(s) 40 may be formed by piercing the underlying metal workpiece 14 with a punching instrument or by shearing the underlying metal workpiece 14 with a cutting instrument. Other metal working approaches not expressly discussed here but nonetheless known in the industry may also employed to form the through holes(s) 40 within the underlying metal workpiece 14.

After the at least one intruding hollow feature 36 is formed in the underlying metal workpiece 14, the top metal workpiece 12 and the underlying metal workpiece 14 are brought together and assembled into the workpiece stack-up assembly 10, as shown in FIG. 3. Suitable fixturing equipment or other metal workpiece positioning equipment may be used to hold the metal workpieces 12, 14 together in the assembled state in preparation for joining. The top metal workpiece 12 and the underlying metal workpiece 14, when assembled into the stack-up assembly 10, overlap to define the overlapping welding region 16 where the top metal workpiece 12 covers the at least one intruding hollow feature 36 defined in the underling metal workpiece 14 as previously described. The workpiece stack-up assembly 10 is now ready to be joined by operation of the remote laser welding apparatus 18, in which the laser beam 28 functions as the welding laser beam 28′. To that end, the workpiece stack-up assembly 10 may be transported to a workstation associated with the remote laser welding apparatus 18 and properly oriented in relation to the remote laser welding apparatus 18 so that the top metal workpiece 12 and the underlying metal workpiece 14 are positioned accordingly.

As depicted best in FIGS. 1 and 4, the top metal workpiece 12 and the underling metal workpiece 14 are then joined together with the assistance of the welding laser beam 28′, which provides the concentrated heat source necessary to carry out the joining method. The welding laser beam 28′ is directed at and impinges the accessible outer surface 20 of the top metal workpiece 12 and, depending on the size and potential grouping of the intruding feature(s), the beam spot 281′ of the welding laser beam 28′ is either trained at the accessible outer surface 20 or advanced relative to the accessible outer surface 20 along a predetermined beam travel pattern. The energy of the welding laser beam 28′ is absorbed by the top metal workpiece 12 to rapidly generate heat in the workpiece 12 and melt a portion of the top metal workpiece 12 above the at least one intruding hollow feature 36 defined in the underlying metal workpiece 14. The resultant molten metal material 64 from the top metal workpiece 12 flows into the at least one intruding hollow feature 36 and wets the interior surface 38 of the underlying metal workpiece 14 that defines the at least one intruding hollow feature 36. In some instances, particularly when the top metal workpiece 12 and the underling metal workpiece 14 are aluminum and steel workpieces, respectively, an intermetallic layer 68 may form along the interior surface 38 of the underlying metal workpiece 14 where metal from the underling metal workpiece 14 (e.g., iron) diffuses into the molten metal material 64 (e.g., molten aluminum).

The molten metal material 64 from the top metal workpiece 12 that flows into the at least one intruding hollow feature 36 is ultimately allowed to solidify within the at least one intruding hollow feature 36 to establish the weld joint 66 that metallurgically secures the top and underlying metal workpieces 12, 14 together. The weld joint 66 is, essentially, a stud 70 having an outer surface 72 that is brazed to the interior surface 38 of the at least one intruding hollow feature 38 defined in the underling metal workpiece 14. In addition to the braze joint established between the stud 70 and the interior surface 38 of the underling metal workpiece 14, the fitted receipt of the stud 70 within the at least one intruding hollow feature 36 and the inherent constraint against relative movement between the stud 70 and the underling metal workpiece 14 due to the braze joint between the them provides weld joint 66 with a mechanical interlocking component that, together with the braze joint, promotes good joint strength. The molten metal material 64 may be allowed to cool and solidify into the stud 70 by halting transmission of the welding laser beam 28′ or relocating the beam spot 281′ of the welding laser beam 28′ away from the molten metal material 64 to another thermally isolated portion of the top metal workpiece 12.

Because the molten metal material 64 of the top metal workpiece 12 flows down into the at least one intruding hollow feature 36 defined in the underling metal workpiece 14, a situation may arise in which the top metal workpiece 12 experiences too much thinning in the area where the weld joint 66 is formed. Under these circumstances, and as shown in FIG. 4, a filler wire 74 may optionally be used to introduce molten filler material 76 into the molten metal material 64 of the top metal workpiece 12 in order to at least partially maintain the thickness 121 of the top metal workpiece 12. In use, the filler wire 74 may be positioned relative to the welding laser beam 28′ so that the filler wire 74 is impinged and melted by the welding laser beam 28′ to produce the molten filler material 76. The filler wire 74 may be forwardly fed into the path of the welding laser beam 28′ as needed to produce a quantity of the molten filler material 76 that is admixed with the molten metal material 64 of the top metal workpiece 12 and which at least partially offsets the quantity of the molten metal material 64 that infiltrates the at least one intruding feature 36. The filler wire 74 may be composed of an alloy whose main alloy constituent is the same as the main constituent of the base metal substrate 32 of the top metal workpiece 12. For example, if the top metal workpiece 12 is an aluminum workpiece, the filler wire 74 is preferably composed of an aluminum alloy such as an Al—Si—Mg alloy. The filler wire 74 may be impinged and melted by the welding laser beam 28′ with or without an inert shielding gas.

As previously mentioned, the joining method is particularly useful when the top metal workpiece 12 is an aluminum workpiece and the underlying metal workpiece 14 is a steel workpiece. In that scenario, the welding laser beam 28′ is directed at and impinges the accessible outer surface 20 of the aluminum workpiece and melts a portion of the aluminum workpiece to create molten aluminum material. The molten aluminum material flows into the at least one intruding hollow feature 36 defined in the underlying steel workpiece and wets the interior surface 38 of the steel workpiece that defines the at least one intruding hollow feature 36. Upon solidification of the molten aluminum material within the at least one intruding feature 36, the weld joint 66 is established in which the outer surface 72 of the stud 70 is brazed to the interior surface 38 of the steel workpiece that defines the at least one intruding feature 36. And, due to the diffusion of iron into the molten aluminum material that infiltrates the at least one intruding hollow feature 36, the intermetallic layer 68 will typically be present and my include Fe—Al intermetallic compounds such as FeAl₃ compounds, Fe₂Al₅ compounds, and possibly other Fe—Al intermetallic compounds.

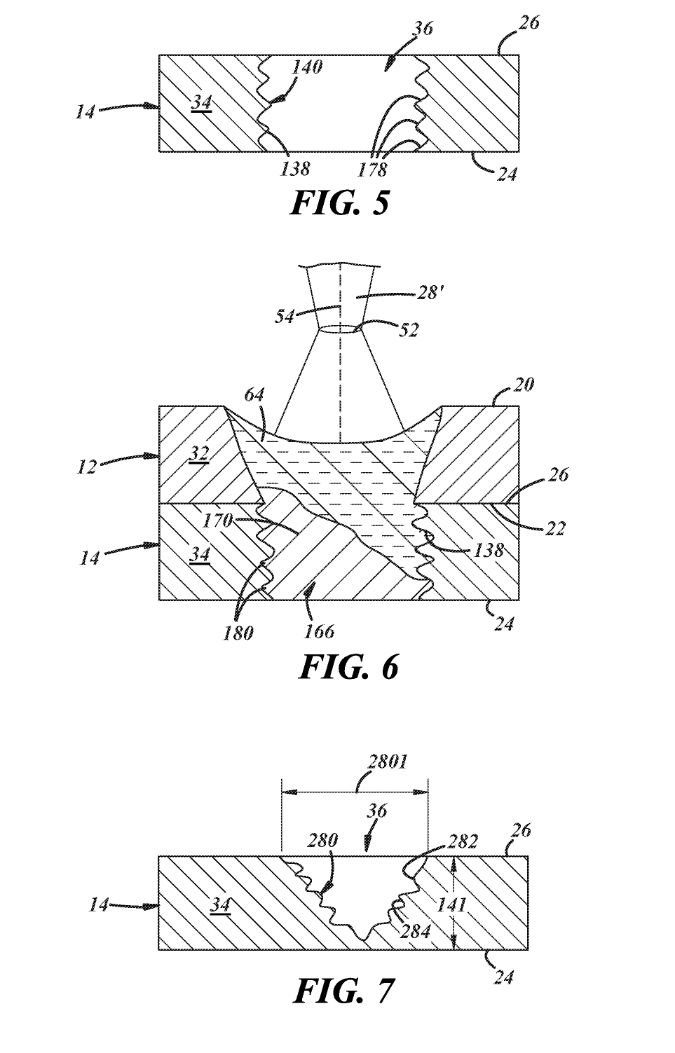

The joining method described above in connection with FIGS. 1-4 is, of course, subject to a variety of variations. For example, as shown in FIGS. 5-6, the intruding hollow feature 36 may be a through hole 140 and the interior surface 138 of the underlying metal workpiece 14 that defines the through hole 140 may be serrated. The serrated interior surface 138 includes one or more notches 178 that are axially spaced apart and extend at least partially along a circumference of the interior surface 138. When the top metal workpiece 12 is melted and the molten metal material 64 of the top metal workpiece flows into the through hole 140, as shown in FIG. 6, the molten metal material 64 fills the notches 178 of the serrated interior surface 138 and ultimately solidifies therein. As such, the stud 170 of the weld joint 166 includes radial fins 180 that increase the mechanical interlocking component of the weld joint 166 and, in particular, serve to strengthen the joint 166 when subjected to various types of loading including shear, tensile, peel, and cross-tension loading. A serrated interior surface 138 may be useful if there is concern that the intermetallic layer 68 (FIG. 4) that may be formed is too hard and brittle. Several different techniques are available for forming the serrated interior surface 138 including using a rotating screw to form the through hole(s) 140 within the underling metal workpiece 14.

As another example, and referring now to FIGS. 7-8, the intruding hollow feature 36 may be a cavity 280 that is open to the adjacent faying surface 22 of the top metal workpiece 12 when the top and underlying metal workpieces 12, 14 are assembled into the workpiece stack-up assembly 10. The cavity 280 only partially traverses the thickness 141 of the underlying metal workpiece 14 and, consequently, acts as a basin that contains the molten metal material 64 from the top metal workpiece 12 to ensure that none of the molten metal material 64 flows through the underlying metal workpiece 14. The cavity 280 may have a diameter 2801 at the faying surface 26 of the underlying metal workpiece 14 similar to that of the through hole 40 described above in connection with FIGS. 2-4 and, further, it may taper as it extends into the underlying metal workpiece away from the faying surface 26 and the overlying top metal workpiece 12, as shown. Additionally, as shown, an interior surface 282 that defines the cavity 280 may be serrated such that the interior surface 282 includes one or more notches 284 that are axially spaced apart and extend at least partially along a circumference of the interior surface 282. The interior surface 282 may be serrated for the same reasons and to achieve the same objectives as previously discussed; that is, when the molten metal material 64 of the top metal workpiece flows into the cavity 280, as shown in FIG. 8, the molten metal material 64 fills the notches 284 of the serrated interior surface 282 and ultimately solidifies therein such that the stud 270 of the weld joint 266 includes radial fins 286 that increase the mechanical interlocking component of the joint 266.

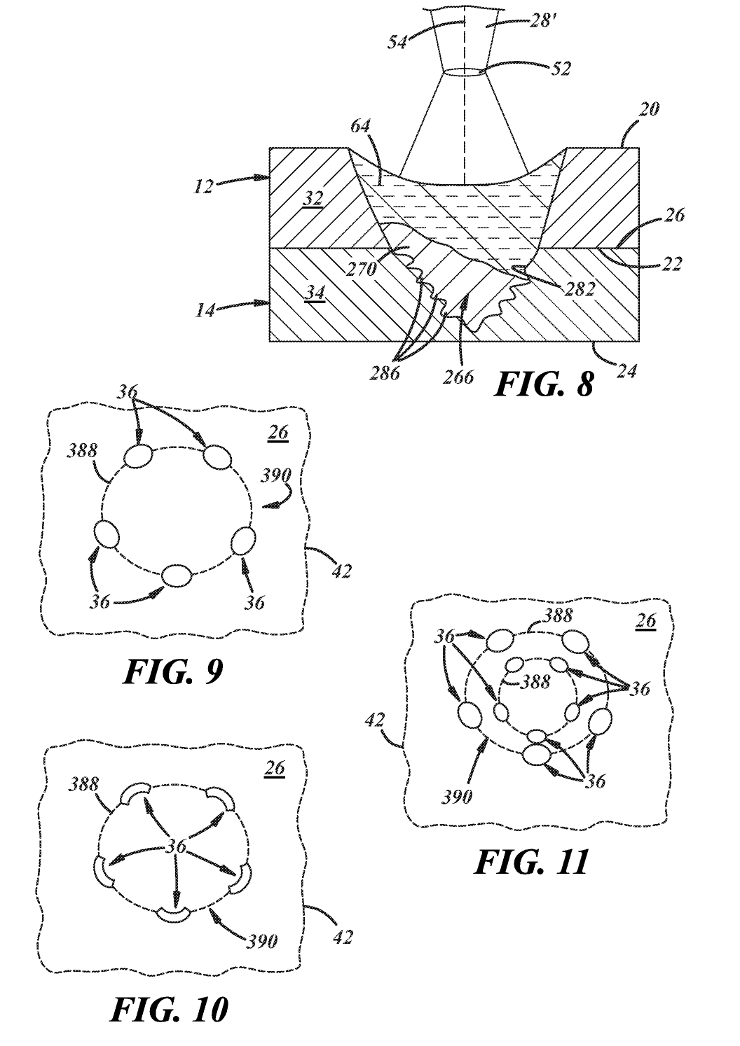

Still further, as illustrated in FIGS. 9-11, the at least one intruding hollow feature 36 (e.g. the through hole(s) 40, the through hole(s) 140, the cavity or cavities 280, etc.) may include a plurality of intruding hollow features 36 that are grouped together and contained within the surface area 42 (see also FIG. 1) that spans the faying surface 26 of the underlying metal workpiece 14. The plurality of intruding hollow features 36 may include anywhere from three to fifteen intruding hollow features 34 of the same or different variety. Moreover, as shown in each of FIGS. 9-11, the plurality of intruding hollow features 36 may be arranged on one or more weld path 388 of a beam travel pattern 390 that is traced by the welding laser beam 28′ along the accessible outer surface 20 of the top metal workpiece 12 during melting of the top metal workpiece 12. The weld path(s) 388 may be a circular weld path (as shown) or it may be another type of weld path including a linear stich weld path, a C-shaped staple weld path, a spiral weld path, or any other shape of weld path. By arranging the plurality of intruding hollow features 36 on one or more weld paths 388, the thinning of the top metal workpiece 12 can be mitigated over the surface area 42 of the faying surface 26 of the underlying metal workpiece 14 that contains the intruding hollow features 36, which may avoid the need to use a filler wire where one might otherwise be needed if only a single intruding hollow feature were implemented.

The workpiece stack-up assembly 10 may also include another additional metal workpiece besides the top and underlying metal workpieces 12, 14, as illustrated in FIGS. 12-13. Referring for the moment to FIG. 12, an alternative embodiment of the workpiece stack-up assembly 10 includes a top metal workpiece 412, a first underlying metal workpiece 414, and a second underlying metal workpiece 492. When assembled into the workpiece stack-up assembly 10, the top metal workpiece 412 overlies the first underlying metal workpiece 414 and includes the accessible outer surface 420 that is impinged by the welding laser beam 28′. The first underlying metal workpiece 414, in turn, overlies the second underlying metal workpiece 492. In that regard, all three metal workpieces 412, 414, 492 overlap to define the overlapping welding region 16 (FIG. 1) with a first faying surface 426 of the first underlying metal workpiece 414 confronting a faying surface 422 of the top metal workpiece 412 to establish a first faying interface 430 and a second faying surface 494 of the first underlying metal workpiece 414 confronting a faying surface 496 of the second underlying metal workpiece 492 to establish a second faying interface 498. The first and second faying interfaces 430, 498 encompass the same breadth of overlapping relationships between the confronting faying surfaces 422, 426, 494, 496 as previously described.

The descriptions of the top metal workpiece 12 and the underlying metal workpiece 14 provided above are equally applicable to the top metal workpiece 412 and the first underlying metal workpiece 414, respectively, that are shown in connection with FIGS. 12-13 and, thus, are fully applicable here except where otherwise stated. The second underlying metal workpiece 492 may be the same as the top metal workpiece 412 or the same as the first underlying metal workpiece 414, in which case the above descriptions of the top or underlying metal workpieces 12, 14 applies, or it may have a different composition. In the embodiment where the top metal workpiece 412 is an aluminum workpiece and the first underlying metal workpiece 414 is a steel workpiece, for example, the second underlying metal workpiece 492 may be an aluminum workpiece but, of course, it could also be another type of metal workpiece such as a steel workpiece. In order to form a weld joint 466 that metallurgically secures the top, first underlying, and second underlying metal workpieces 412, 414, 492, each of the the first underlying metal workpiece 414 and the second underlying metal workpiece 492 includes at least one intruding hollow feature 436′, 436″ that can receive molten metal material 64 from the top metal workpiece 412 when a portion of the top metal workpiece 412 is melted above the intruding hollow features 436′, 436″.

The at least one intruding hollow feature 436′ defined in the first underlying metal workpiece 414 is a through hole 440 that is defined by an internal surface 438 of the first underlying metal workpiece 414 similar to that shown in FIGS. 2-4. The through hole 440 defined in the first underlying metal workpiece 414 communicates with the at least one intruding hollow feature 436″ defined in the second underlying metal workpiece 492 to provide a conduit through which molten metal material 64 from the top metal workpiece 412 can flow and reach the intruding hollow feature 436″ defined in the second underlying metal workpiece 492. As for the intruding hollow feature 436″ defined in the second underlying metal workpiece 492, it may be a through hole or a cavity open to the adjacent faying surface 494 of the first underlying metal workpiece 414 as described above. Each of an internal surface 438 that defines the through hole 440 defined in the first underlying metal workpiece 414 and an internal surface 500 that defines the through hole or cavity in the second underlying metal workpiece 492 may be serrated, or not, for the reasons explained above regarding the enhancement of mechanical interlocking in the ultimately-formed weld joint 466. A plurality of the intruding hollow features 436′, 436″ in the first and second underlying metal workpieces 414, 492 may also be employed, if desired, as shown in FIGS. 9-11.

The joining of the top, first underlying, and second underlying metal workpieces 412, 414, 492 is accomplished in generally the same manner as described above. Indeed, after the workpieces 412, 414, 492 are assembled into the workpiece stack-up assembly 10, the welding laser beam 28′ serving as the concentrated heat source is directed at and impinges the accessible outer surface 420 of the top metal workpiece 412 to melt a portion of the top metal workpiece 412, as illustrated in FIG. 13. The resultant molten metal material 64 of the top metal workpiece 412 flows into and through the through hole 440 defined in the first underlying metal workpiece 414 and into the intruding hollow feature 438″ (through hole or cavity) defined in the second underlying metal workpiece 492. The molten metal material 64 wets the interior surface 438 of the through hole 440 defined in the first underlying metal workpiece 414 and either wets or commingles with the interior surface 500 of the intruding hollow feature 438″ defined in the second underlying metal workpiece 492 depending on the composition of the based metal substrate of the second underlying metal workpiece 492). The molten metal material may also fill any notches that may be defined by the interior surfaces 438, 500. The molten material 64 is allowed to solidify into a weld joint 466 characterized by a stud 470 having an outer surface 472 that is brazed to the interior surface 438 of the through hole 440 and brazed or fused (depending on the composition of the based metal substrate of the second underlying metal workpiece 492) to the interior surface 500 of the intruding feature 438″ defined by the second underlying metal workpiece 414.

Other variations and adaptions of the joining methods described above in connection with FIGS. 1-13 are certainly possible despite not being expressely described in the text and shown in the accompanying drawing figures. For example, and referring back to FIGS. 1-4 for the moment, the melting of a portion of the top metal workpiece 12 with the welding laser beam 28′, which preferably serves as the concentrated heat source, may be carried out by directing the welding laser beam 28′ at the accessible outer surface 20 of the top metal workpiece and impinging the accessible outer surface 20 to generate heat directly within the top metal workpiece 12 as needed to cause melting, as described. In other scenarios, however, a metal workpiece may be disposed over the top metal workpiece 12 such that the welding laser beam 28′ impinges that overlying metal workpiece first and either melts through the overlying metal workpiece into the top metal workpiece 12 or generates enough heat in the overlying metal workpiece to cause melting in the top metal workpiece 12 to thereby create the molten metal material 64 that infiltrates the at least one intruding hollow feature 36 defined in the underlying metal workpiece 14. In those situations where a metal workpiece overlies the top metal workpiece 12, the extra overlying metal workpiece preferably has the same base metal composition as the top metal workpiece 12; that is, if the top metal workpiece 12 is an aluminum metal workpiece, the extra overlying metal workpiece may also be an aluminum workpiece of the same general type describe above in connection with the top metal workpeice 12.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

What is claimed is:

1. A method of welding a workpiece stack-up assembly that includes dissimilar metal workpieces, the method comprising:
providing a workpiece stack-up assembly that includes a top metal workpiece and an underlying metal workpiece that overlap to define an overlapping welding region, the top metal workpiece overlying the underlying metal workpiece and covering at least one intruding hollow feature defined in the underlying metal workpiece, the top metal workpiece comprising a base metal substrate and the underlying metal workpiece comprising a base metal substrate, the base metal substrate of the top metal workpiece being different than the base metal substrate of the underlying metal workpiece and having a melting point that is less than a melting point of the base metal substrate of the underlying metal workpiece;
melting a portion of the top metal workpiece with a concentrated heat source to create molten metal material of the top metal workpiece that flows into the at least one intruding hollow feature defined in the underlying workpiece; and
allowing the molten metal material of the top metal workpiece to solidify in the at least one intruding hollow feature defined in the underlying workpiece to establish a weld joint that metallurgically secures the top metal workpiece and the underlying metal workpiece together.

2. The method set forth in claim 1, wherein providing the workpiece stack-up assembly comprises:
forming the at least one intruding hollow feature in the underlying metal workpiece; and
assembling the top metal workpiece and the underlying metal workpiece into the workpiece stack-up assembly.

3. The method set forth in claim 2, wherein forming the at least one intruding hollow feature comprises directing a laser beam at the underlying metal workpiece to melt and remove material from the underlying metal workpiece.

4. The method set forth in claim 1, wherein melting the portion of the top metal workpiece with the concentrated heat source comprises:
directing a laser beam at an accessible outer surface of the top metal workpiece; and
training a beam spot of the laser beam at the accessible outer surface or advancing the beam spot relative to the accessible outer surface along a beam travel pattern to melt the portion of the top metal workpiece.

5. The method set forth in claim 4, wherein directing the laser beam at the accessible outer surface of the top metal workpiece comprises operating a scanning optic laser head to direct the laser beam at the accessible outer surface of the top metal workpiece with the laser beam having a focal length that ranges from 0.4 meters to 2.0 meters.

6. The method set forth in claim 1, wherein the intruding hollow feature is a through hole that fully traverses a thickness of the underlying metal workpiece.

7. The method set forth in claim 6, wherein the through hole is defined by an interior surface of the underlying metal workpiece, and wherein the interior surface is serrated such that the interior surface includes one or more notches that are axially spaced apart and extend at least partially along a circumference of the interior surface.

8. The method set forth in claim 1, wherein the intruding hollow feature is a cavity that is open to an adjacent faying surface of the top metal workpiece and only partially traverses a thickness of the underlying metal workpiece.

9. The method set forth in claim 8, wherein the cavity is defined by an interior surface of the underlying metal workpiece, and wherein the interior surface is serrated such that the interior surface includes one or more notches that are axially spaced apart and extend at least partially along a circumference of the interior surface.

10. The method set forth in claim 1, wherein the workpiece stack-up assembly includes a first underlying metal workpiece and a second underlying metal workpiece, the top metal workpiece overlying the first underlying metal workpiece, and the first underlying metal workpiece overlying the second underlying metal workpiece, the first underlying metal workpiece defining at least one intruding hollow feature that that fully traverses a thickness of the first underlying metal workpiece and communicates with at least one intruding feature defined in the second underlying metal workpiece, and wherein the molten metal material of the top metal workpiece flows into and through the at least one intruding hollow feature defined in the first underlying metal workpiece and also into the at least one intruding hollow feature defined in the second underlying metal workpiece.

11. The method set forth in claim 10, wherein the intruding hollow feature defined in the second underlying metal workpiece is a cavity that is open to an adjacent faying surface of the first underlying metal workpiece and only partially traverses a thickness of the second underlying metal workpiece.

12. The method set forth in claim 11, wherein the cavity is defined by an interior surface of the second underlying metal workpiece, and wherein the interior surface is serrated such that the interior surface includes one or more notches that are axially spaced apart and extend at least partially along a circumference of the interior surface.

13. The method set forth in claim 1, wherein the top metal workpiece is an aluminum workpiece and the underlying metal workpiece is a steel workpiece.

14. The method set forth in claim 1, wherein the at least one intruding hollow feature comprises a plurality of intruding hollow features.

15. A method of welding a workpiece stack-up assembly that includes dissimilar metal workpieces, the method comprising:
forming at least one intruding hollow feature in a steel workpiece;
assembling an aluminum workpiece and the steel workpiece into a workpiece stack-up assembly in which the aluminum workpiece overlaps the steel workpiece and covers the at least one intruding hollow feature defined in the steel workpiece;
melting a portion of the aluminum workpiece with a laser beam to create molten aluminum material that flows into the at least one intruding hollow feature defined in the steel workpiece; and
allowing the molten aluminum material to solidify in the at least one intruding hollow feature defined in the steel workpiece to establish a weld joint that secures the aluminum workpiece and the underlying steel workpiece together.

16. The method set forth in claim 15, wherein the intruding hollow feature is a through hole that fully traverses a thickness of the steel workpiece, or wherein the intruding hollow feature is a cavity that is open to an adjacent faying surface of the aluminum workpiece and only partially traverses a thickness of the steel workpiece.

17. The method set forth in claim 15, wherein an interior surface of the steel workpiece that defines the intruding hollow feature is serrated.

18. The method set forth in claim 15, wherein the step of melting the portion of the aluminum workpiece with a laser beam comprises:
directing the laser beam at an accessible outer surface of the aluminum workpiece from a scanning optic laser head of a remote laser welding apparatus, the laser beam having a focal length that ranges from 0.4 meters to 2.0 meters; and
training a beam spot of the laser beam at the accessible outer surface or advancing the beam spot relative to the accessible outer surface along a beam travel pattern to melt the portion of the aluminum workpiece.

19. The method set forth in claim 15, wherein assembling the aluminum workpiece and the steel workpiece into a workpiece stack-up comprises assembling the aluminum workpiece, the steel workpiece, and an additional aluminum workpiece into the workpiece stack-up, wherein the aluminum workpiece overlaps the steel workpiece and covers the at least one intruding feature defined in the steel workpiece, which fully traverses a thickness of the steel workpiece, and wherein the steel workpiece overlaps the additional aluminum workpiece such that the at least one intruding hollow feature defined in the steel workpiece communicates with at least one intruding feature defined in the additional aluminum workpiece.

20. The method set forth in claim 15, further comprising:
positioning a filler wire relative to the laser beam so that the filler wire is impinged by the laser beam to melt the filler wire and introduce molten filler material into the molten aluminum material.
